(19) United States
(12) Patent Application Publication
(10) Pub. No.: US 2017/0291112 A1
(43) Pub. Date: Oct. 12, 2017

(54) CUSTOMIZABLE FABRIC BASED ARTICLE

(71) Applicant: Glenn Ann Bayne, Yuba City, CA (US)

(72) Inventor: Glenn Ann Bayne, Yuba City, CA (US)

(21) Appl. No.: 15/091,799

(22) Filed: Apr. 6, 2016

(51) Int. Cl. A63H 3/52; A44C 27/00; B32B 7/06; B32B 5/26; B32B 7/08; B32B 7/12; A47G 9/02; B32B 3/06

(52) U.S. Cl. CPC A63H 3/52; A47G 9/0223; A44C 27/001; B32B 3/06; B32B 5/26; B32B 7/08; B32B 7/12; B32B 7/06; B32B 2250/20; B32B 2451/00

(57) ABSTRACT

Disclosed is a fabric based article, such as for example, a blanket that may be customizable. For aesthetic purposes, the fabric based article may include a design, such as that of a doll. Additionally, the fabric based article may include a plurality of attachments. A visual appearance of the plurality of attachments may correspond to one or more of an article of clothing and an accessory. Further, each attachment may include one or more fasteners. Likewise, the fabric based article may include one or more fasteners disposed on one or more portions of the design. Moreover, a fastener of the one or more fasteners disposed on the one or more portions of the design may be configured to fasten with a fastener included in an attachment of the plurality of attachments in order to customize a visual appearance of the fabric based article.

### FIELD OF THE INVENTION

The invention generally relates to fabric based articles. More specifically, the invention relates to a fabric based article, such as for example a blanket, configured to engage with a plurality of attachments according to a design.

### BACKGROUND

Fabric based articles, such as for example, blankets, tapestry and rugs are commonly used in daily life. Such articles have a primary utility associated with them. For example, a blanket may be associated with a primary utility of providing warmth and comfort to a user. Similarly, a tapestry may be associated with the primary utility of being used a decoration on a wall.

Further, for aesthetic purposes, fabric based articles may incorporate colors and designs. However, the visual appearance of such fabric based articles is largely fixed at the time of manufacture. Accordingly, subsequent customization of the visual appearance of fabric based articles is currently either not possible or limited.

Additionally, existing fabric based articles are limited to providing only the primary utility and are therefore not versatile. Moreover, fabric based articles intended for use by a certain class of users, such as for example, children are not interactive.

Accordingly, it is desirable to provide fabric based articles whose visual appearance may be customizable. Further, it is also desirable to provide fabric based articles that may be more interactive to users such as, children.

### BRIEF OVERVIEW

Disclosed is a fabric based article that may be customizable. The fabric based article of may be substantially a two-dimensional article. For instance, the fabric based article may be one or more of a blanket, a tapestry and a rug. Further, the fabric based article may be configured to provide each of a primary utility and a secondary utility. The secondary utility may correspond to usability of the fabric based article as a toy.

For aesthetic purposes, the fabric based article may include a design. For instance, the design may be that of a doll. Further, the design may include an outline of one or more objects such as, for example, but not limited to, a doll, a character and an animal. Further, the design may be imprinted on a side of the fabric based article. Alternatively, the design may be embodied in a plurality of fabric pieces attached to a side of the fabric based article. Moreover, in some embodiments, the plurality of fabric pieces may be irremovably attached to the fabric based article.

Additionally, the fabric based article may include a plurality of attachments. Furthermore, a shape of one or more attachments of the plurality of attachments may conform to one or more portions of the design. Further, the fabric based article may include one or more pouches configured to store the plurality of attachments.

Moreover, a visual appearance of the plurality of attachments may correspond to one or more of an article of clothing and an accessory. For example, the article of clothing may be one or more of, but not limited to, a shirt, t-shirt, blouse, top, coat, jacket, hat, cap, scarf, skirt, pant, shorts, gloves and socks. Similarly, the accessory may be one or more of, but not limited to, hair, hair band, hair clip, hair pin, hair grip, hair braid, crown, ear-rings, necklace, bracelet, ring, badge, wrist band, wrist watch and goggles.

Further, each attachment may include one or more fasteners. Likewise, the fabric based article may include one or more fasteners disposed on one or more portions of the design. Moreover, a fastener of the one or more fasteners disposed on the one or more portions of the design may be configured to fasten with a fastener included in an attachment of the plurality of attachments. Further, each of a fastener of the one or more fasteners disposed on the one or more portions of the design and a fastener included in an attachment of the plurality of attachments may include one or more of a Velcro based fastener, a snap-button based fastener and a glue based fastener.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a fabric based article depicting customizable hair portion of a design according to some embodiments.

FIG. 2 illustrates a fabric based article configured depicting customizable shirt portion according to some embodiments.

FIG. 3 illustrates a fabric based article depicting customizable hair portion of the design according to a first hair style.

FIG. 4 illustrates a fabric based article depicting customizable hair portion of the design according to a second hair style.

FIG. 5 illustrates a fabric based article depicting customizable hair portion of the design according to a third hair style.

FIG. 6 illustrates a fabric based article depicting customizable hair portion of the design according to a fourth hair style.

FIG. 7 illustrates a fabric based article depicting the customizable attachments such as clothes and accessories separated from the fabric based article.

FIG. 8 illustrates a fabric based article depicting the customizable attachments such as clothes and accessories fastened to the fabric based article.

FIG. 9 illustrates the use of fabric based articles by children as a toy.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of film production, embodiments of the present disclosure are not limited to use only in this context.

### OVERVIEW

According to some embodiments, the present disclosure relates to a fabric based article such as, for example, a blanket for children. Further, the blanket may also be used as a rug and/or a tapestry.

Further, the blanket may include an outline of a character such as, for example, a boy and/or a girl of various ethnicities. Additionally, each part of the character may be customizable by attaching Velcro based attachments corresponding to one or more of clothing, hair style, lips, eyes and hats to the character. In some instances, the character may also be an animal. Further, in some embodiments, the blanket may have a pouch in which all the attachments may be stored.

As a result, the blanket may also function as a playing doll for the child to dress up and/or customize as they wish.

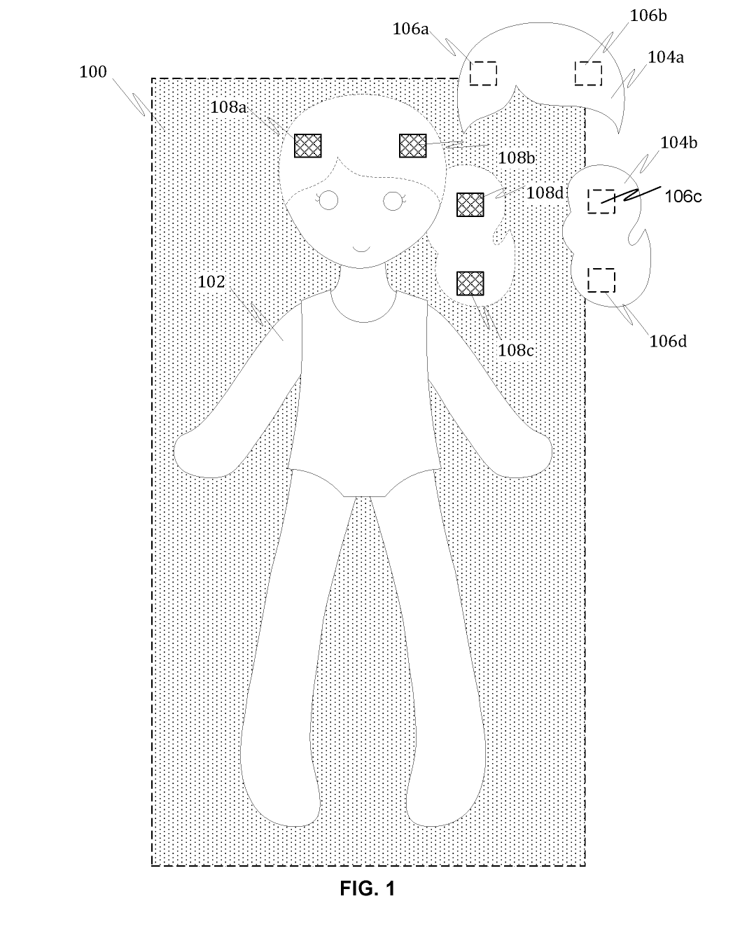

FIG. 1 illustrates a fabric based article 100 according to some embodiments. In general, the fabric based article 100 may be any article including a fabric. For instance, as shown, the fabric based article 100 may be substantially a two-dimensional article such as for example, one or more of a blanket, a tapestry and a rug. Other examples of the fabric based article 100 may include bed spread, pillow cover, table cloth, curtain, seat cover, sofa cover and so on. Accordingly, in some embodiments, the fabric based article 100 may include a hollow space to accommodate an object, such as a pillow.

The fabric based article 100 may be made from one or more types of fabrics. The fabrics may be woven or non-woven. Examples of fabrics include, but are not limited to, cotton, silk, polyester, rayon and nylon. The fabric may include one or more patterns and colors to enhance visual appeal. Additionally, in some embodiments, the fabric based article 100 may include one or more embellishments (not shown in figure).

Further, the fabric based article 100 may be made from one or more layers of fabrics. For instance, using multiple layers of fabrics may provide an increased level of comfort and warmth to a user when the fabric based article 100 is used as a blanket. In some embodiments, multiple layers of the same fabric type may be used to form the fabric based article 100. In some other embodiments, multiple layers of different fabric types may be used. As a result of using multiple layers, strength of fabric based article 100 may be improved. For instance, the multiple layers may provide increased toughness to enable the fabric based article 100 to be used as a rug.

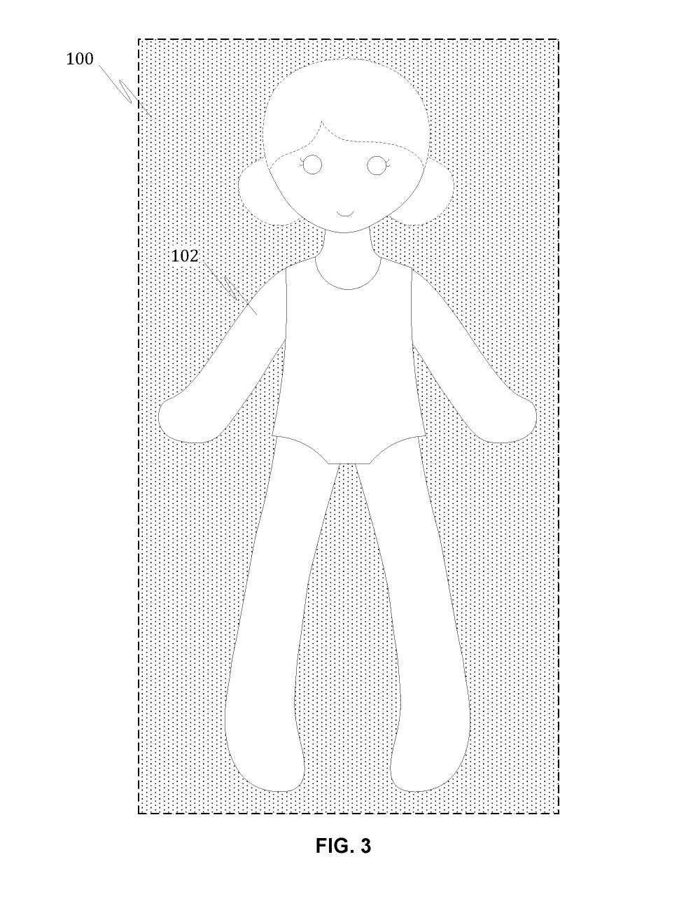

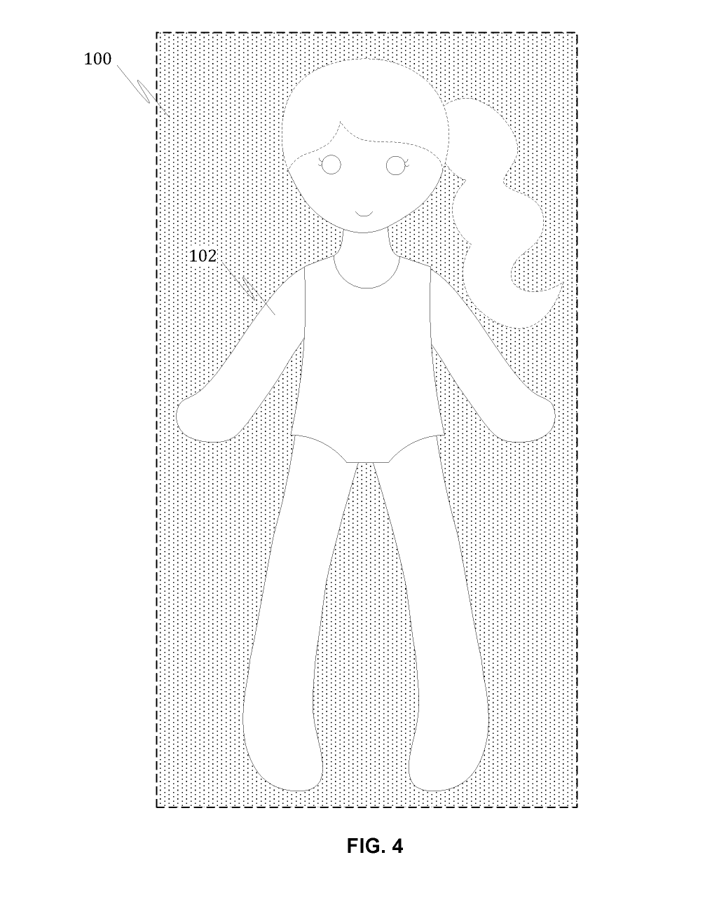

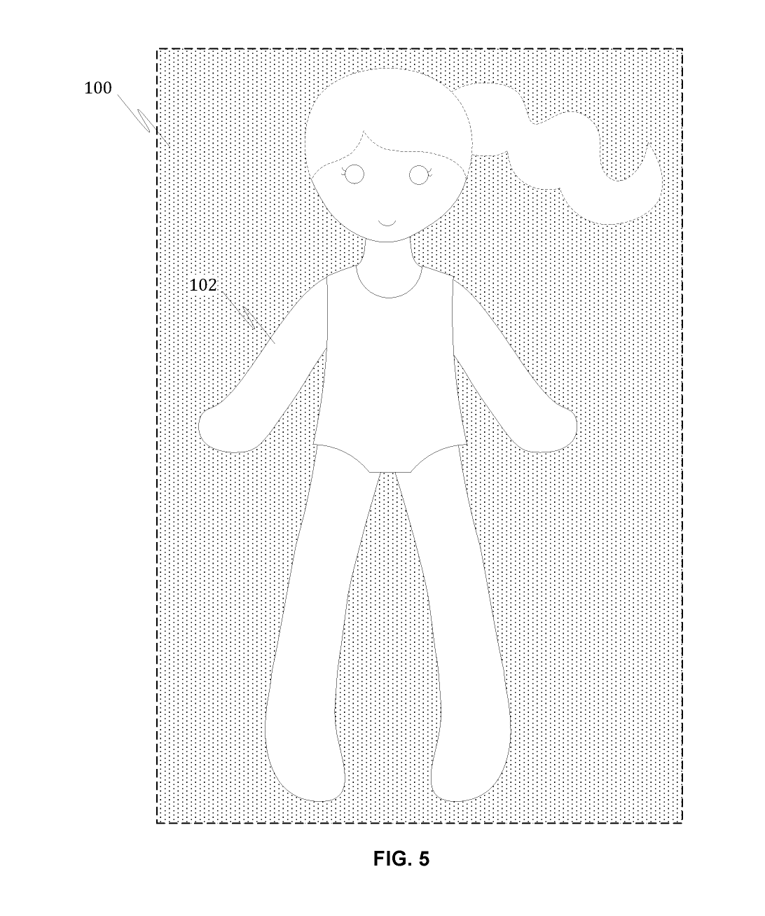

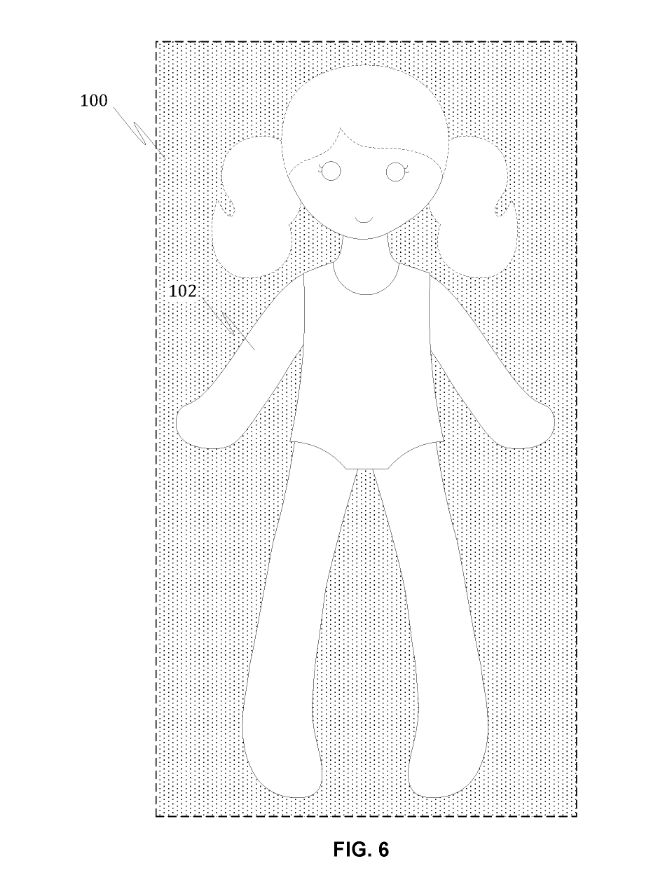

For aesthetic purposes, the fabric based article 100 may include one or more designs 102 on one or more sides of the fabric based article 100. For example, as illustrated an upper side of the fabric based article 100 may include a design 102 of a doll. Further, in some embodiments, the design 102 may include an outline of one or more objects such as, for example, but not limited to, a doll, a character and an animal. For example, as illustrated in FIG. 1, the fabric based article 100 may include an outline of a doll. Further, as illustrated in FIG. 3 to 6, the fabric based article 100 may be made to exhibit different designs of the doll, such as having different hair styles. The outline may visually demarcate multiple regions of the design corresponding to different parts of the doll. For example, the outline may demarcate one or more of a face, hair, eyes, lips, ears, neck, torso, arms, hands, legs and feet. The demarcation provided by the outline may facilitate a user in customizing visual appearance of the fabric based article 100. For instance, the outline may indicate the regions of the design that may be customized. As an example, a child looking at the outline may be able to understand that a certain portion of the doll such as the hair may be customized.

Further, in some embodiments, the design 102 may be imprinted on a side of the fabric based article 100. For example, the design 102 may be imprinted using one or more dyes using methods of fabric printing known in the art. As another example, the design 102 may be imprinted on the fabric based article using embroidery.

Alternatively, in some other embodiments, the design 102 may be embodied in a plurality of fabric pieces attached to a side of the fabric based article 100. For example, the fabric based article 100 may include a base fabric upon which the plurality of fabric pieces may be attached in order to create the design. Accordingly, as shown in FIG. 1, the design may be composed of plurality of fabric pieces corresponding to different portions of the doll, such as hair, shirt and pants.

Moreover, in some embodiments, the plurality of fabric pieces may be irremovably attached to the fabric based article 100. For instance, the plurality of fabric pieces may be irremovably attached using one or more fastening operations such as, for example, but not limited to, sewing, knitting, weaving and gluing.

Additionally, in some embodiments, the plurality of fabric pieces may each be plain in color and design. For example, each fabric piece may be colored white without any pattern while an outline is provided in a darker color. Accordingly, the design may clearly exhibit the various parts of the doll while also indicating the possibility of being customized.

Alternatively, in some embodiments, one or more fabric pieces may include a design. For example, each of the fabric pieces illustrated in FIG. 1 may include a visual pattern and/or a color corresponding to a default visual appearance of the doll. For instance, the fabric pieces corresponding to the body of the doll may include a default t-shirt and default shorts. Accordingly, the fabric based article 100 may exhibit a default visual appearance of the design that may be aesthetically appealing.

Additionally, the fabric based article 100 may include a plurality of attachments 104, such as for example, attachments 104a and 104b corresponding to the hair portion of the doll. Accordingly, in some embodiments, a shape of one or more attachments of the plurality of attachments 104 may conform to one or more portions of the design 102. For instance, as shown, a shape of the attachment 104a may be identical/similar to a corresponding region of the design 102. Accordingly, the attachment 104a may be configured to fit within the outline demarcating the corresponding region of the design 102.

Moreover, a visual appearance of the plurality of attachments 104 may correspond to one or more of an article of clothing and an accessory. For example, the article of clothing may be one or more of, but not limited to, a shirt, t-shirt, blouse, top, coat, jacket, hat, cap, scarf, skirt, pant, shorts, gloves and socks. Similarly, the accessory may be one or more of, but not limited to, hair, hair band, hair clip, hair pin, hair grip, hair braid, crown, ear-rings, necklace, bracelet, ring, badge, wrist band, wrist watch and goggles.

Accordingly, an attachment 104 may include a design. For example, the attachments 104a-b may include design that visually depicts hair. Further, the attachments 104a-b may be colored to indicate hair of a certain type. The attachments 104a-b may be provided in a variety of designs and/or colors. For instance, the attachments 104a-b may be provided in three variations namely blonde, red-head and brunette. Accordingly, the design 102 of the doll may be customized with one of the three variations according to the user's wish.

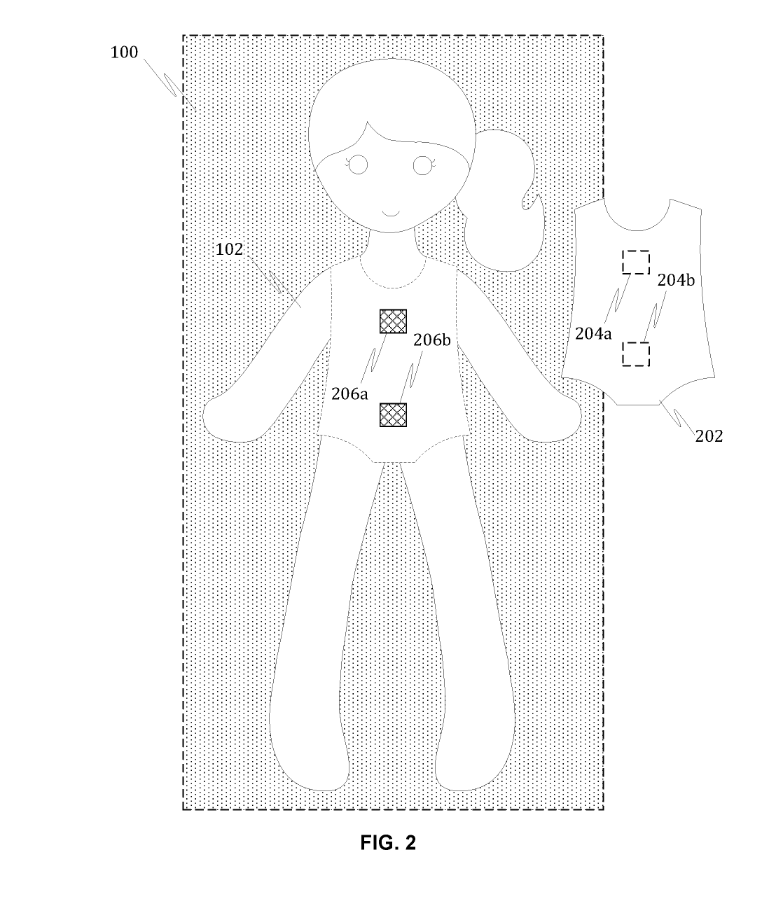

Similarly, as illustrated in FIG. 2, the attachment 202 may correspond to a blouse or a t-shirt configured to be attached to a corresponding portion of the design 102 such as, the torsal portion of the doll.

Further, in some embodiments, the fabric based article 100 may include one or more pouches (not shown in figure) configured to store the plurality of attachments 104.

In order to provide customization, a portion of the fabric based article 100 and/or the plurality of attachments 104 may be configured in such a way that the plurality of attachments 104 may be attached to corresponding portions of the design 102. In some embodiments, this may be achieved using a fastening based mechanism. Accordingly, each attachment 104 may include one or more fasteners 106, such as for example, 106a-d. For instance, as illustrated, the attachment 104a may include fasteners 106a and 106b. Similarly, the attachment 104b may include fasteners 106c and 106d. Additionally, the one or more fasteners 106 may be incorporated in each attachment 104 by using operations such as, for example, but not limited to, sewing, knitting, weaving and gluing.

Further, the one or more fasteners 106 may be incorporated on one or more sides of each attachment 104. In some embodiments, the one or more fasteners 106 may be provided on only one side, such as a lower side of the attachment 104 as shown in FIG. 1. Accordingly, the lower side of the attachment 104 may be configured to be facing the corresponding portion of design 102 when the attachment 104 is fastened.

However, in embodiments where the one or more fasteners 106 are provided on both sides of the attachment 104, the attachment 104 may include designs on both sides. For example, an upper side of the attachment 104 may include a first design and a lower side of the attachment 104 may include a second design. For instance, the upper side of attachments 104a-b may include design of blonde hair, while the lower side of the attachments 104a-b may include design of brunette hair. Further, since the one or more fasteners 106 may be disposed on both sides of the attachments 104a-b, a user may be enabled to attach the attachments 104a-b in one of two ways. In other words, the attachments 104a-b may be attached with either the upper side or the lower side being exposed. Accordingly, a broader range of customization of the fabric based article 100 may be possible.

Further in order to secure the attachments 104 with corresponding portion of the design 102, the fabric based article 100 may include one or more fasteners 108 disposed on one or more portions of the design 102. For instance, as illustrated, a portion of the design 102 corresponding to hair of the doll may include fasteners 108a-d.

Moreover, a fastener 108 of the one or more fasteners 108 disposed on the one or more portions of the design 102 may be configured to fasten with a fastener 106 included in an attachment 104 of the plurality of attachments 104. Further, each fastener 106 of the one or more fasteners 108 disposed on the one or more portions of the design 102 and a fastener 106 included in an attachment 104 of the plurality of attachments 104 may include one or more of a Velcro based fastener, a snap-button based fastener and a glue based fastener.

For instance, the fastener 106a may be configured to engage with fastener 108a in order to provide a secure fastening of attachment 104a to a hair portion of the design 102. As an example, the fastener 106a may be male portion of a snap-button based fastener while the fastener 108a may be a female portion of the snap-button based fastener. As another example, the fastener 106a may be a hook portion of a Velcro based fastener while the fastener 108a may be a loop portion of the Velcro based fastener.

In general, the number of fasteners 106 corresponding to each attachment 104 may vary depending on an area of the corresponding attachment 104. For example, an attachment 104 having a larger area may include two or more fasteners 106 in order to provide a stronger attachment with the corresponding portion of the design 102 on the fabric based article 100. Likewise, a positioning of the fasteners 106 on an attachment 104 may depend on several factors such as shape and area of the attachment 104. For example, in some instances where the area of the attachment 104 is relative large, the fasteners 106 may be disposed across the area.

Further, in some instances, a shape and size of a fastener 106 may also be tailored depending on the shape and size of an attachment 104. For example, as illustrated in FIG. 1, the fasteners 106a-b may be of a rectangular shape. However, in other embodiments, the fasteners 106a-b may be in the form of a strip spanning the periphery of the attachment 104a.

Furthermore, in some embodiments, the number of fasteners 108 and positioning of fasteners 108 may be based on the corresponding number and positioning of fasteners 106.

Further, in some embodiments, the fabric based article 100 may be configured to provide each of a primary utility and a secondary utility. For instance, the primary utility may be one or more of use as a blanket, a rug and a tapestry. In some embodiments, the fabric based article 100 may be associated with a single primary utility, such as for use as a blanket. However, in some embodiments, the fabric based article 100 may be configured to be a multi-purpose article having multiple primary uses such as use as a blanket, rug and tapestry.

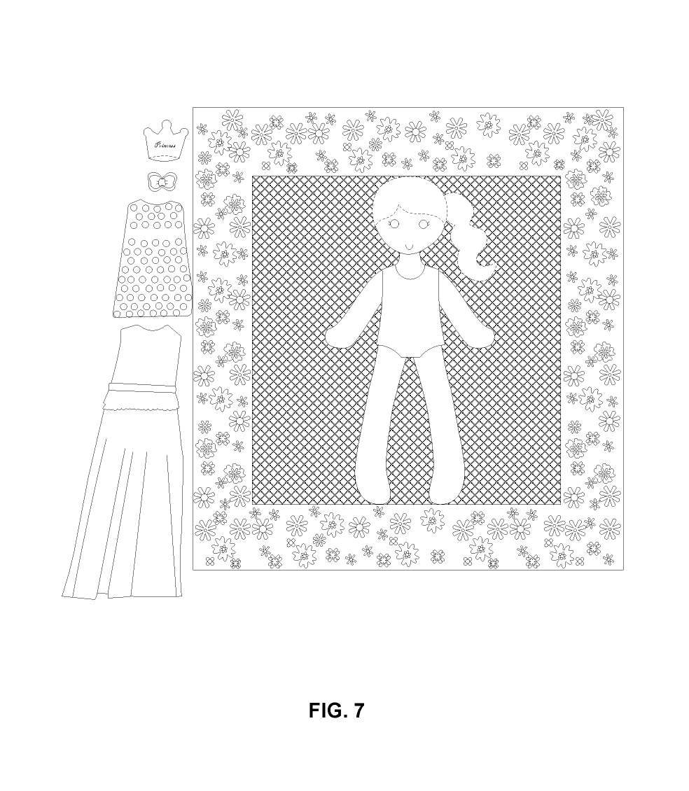

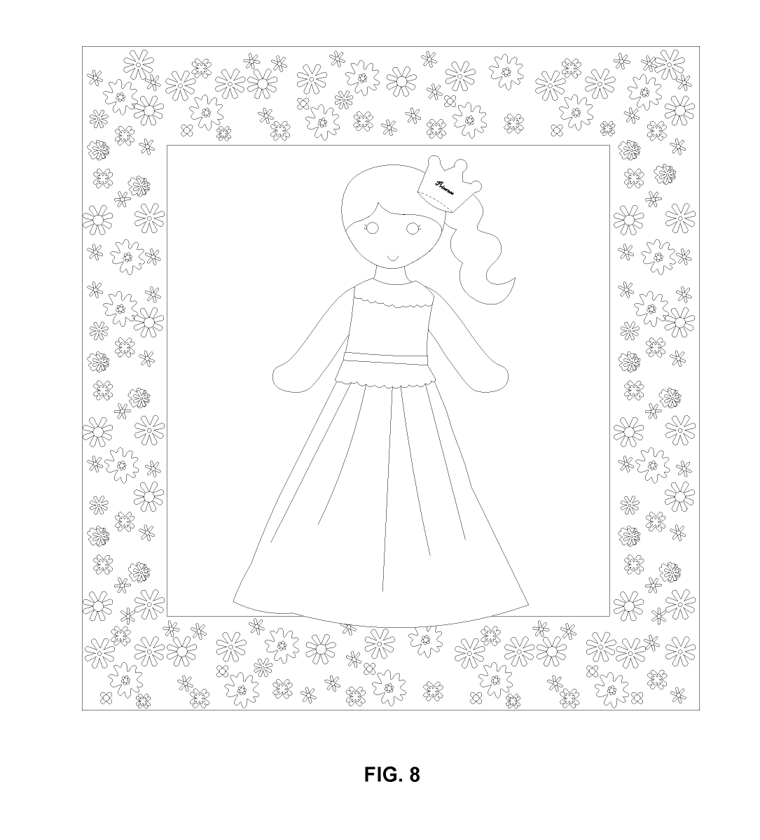

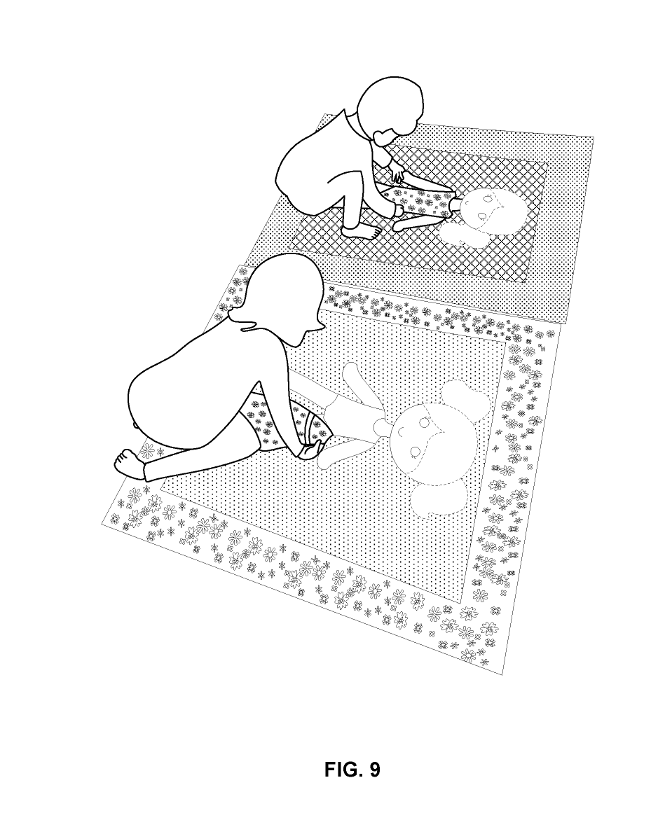

Further, the secondary utility may correspond to usability of the fabric based article 100 as a toy as illustrated in FIG. 9. For example, as illustrated in FIG. 7, the child may be provided with the attachments 104 corresponding to clothes such as a dress and accessories such as crown and bow. Accordingly, a child may be able to interact with the fabric based article 100 by identifying the correct attachment 104 corresponding to a portion of the design 102 of the doll and fastening the attachment 104. As a result, the child may be able to create a customization of the fabric based article 100 as depicted in FIG. 8. Further, since multiple variations of the attachments 104 may be provided for a certain portion of the design 102, the child may choose a desired variation for each attachment. For example, the child may be able to mix and match different attachment variations of hair style, hair color, skirt/shirt and pants/shorts. Such an activity may be highly enjoyable to a child while it also facilitates development of cognitive abilities.

### III. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A fabric based article configured to be customizable, the fabric based article comprising:
a design;
at least one first fastener disposed on at least one portion of the design; and
a plurality of attachments, wherein each attachment comprises at least second one fastener.

2. The fabric based article of claim 1, is a blanket.

3. The fabric based article of claim 1, is at least one of a tapestry and a rug.

4. The fabric based article of claim 1, wherein the design comprises a design of a doll.

5. The fabric based article of claim 1, wherein an attachment of the plurality of attachments is a fabric based attachment.

6. The fabric based article of claim 4, wherein a visual appearance of the plurality of attachments corresponds to at least one of the following: an article of clothing and an accessory.

7. The fabric based article of claim 5, wherein the article of clothing is at least one of a shirt, top, coat, jacket, hat, cap, scarf, skirt, pant, shorts, gloves and socks.

8. The fabric based article of claim 5, wherein the accessory is at least one of hair, hair band, hair clip, hair pin, hair grip, hair braid, ear-rings, necklace, bracelet, ring, badge, wrist band, wrist watch and goggles.

9. The fabric based article of claim 1, wherein a shape of at least one attachment of the plurality of attachments conforms to at least one portion of the design.

10. The fabric based article of claim 1, wherein the at least one first fastener is configured to attach to the at least one second fastener.

11. The fabric based article of claim 10, wherein each of the at least one first fastener and the at least one second fastener is at least one of a Velcro based fastener, a snap-button based fastener and a glue based fastener.

12. The fabric based article of claim 1, wherein the design is imprinted on a side of the fabric based article.

13. The fabric based article of claim 1, further comprising a plurality of fabric pieces attached to at least one side of the fabric based article, wherein the design is embodied in the plurality of fabric pieces.

14. The fabric based article of claim 12, wherein the plurality of fabric pieces are irremovably attached to the fabric based article.

15. The fabric based article of claim 1, wherein the design comprises an outline of at least one of a doll, a character and an animal.

16. The fabric based article of claim further comprising at least one pouch configured to store the plurality of attachments.

17. The fabric based article of claim 1, being substantially a two-dimensional article.

18. The fabric based article of claim 1, configured to provide each of a primary utility and a secondary utility, wherein the secondary utility corresponds to usability of the fabric based article as a toy.
